(19) United States
(12) Patent Application Publication
(10) Pub. No.: US 2003/0050957 A1
(43) Pub. Date: Mar. 13, 2003

(54) Delegating scheduling tasks to clients

(76) Inventor: Atul Hatalkar, Chandler, AZ (US)

Correspondence Address: Timothy N. Trop, TROP, PRUNER & HU, P.C., 8554 KATY FWY., STE. 100, HOUSTON, TX, 77024-1805, US

(21) Appl. No.: 09/948,873

(22) Filed: Sep. 7, 2001

(51) Int. Cl. G06F 15/16; G06F 9/00

(52) U.S. Cl. 709/201; 709/102

(57) ABSTRACT

A managed network may handle the scheduling of end-to-end operations by enabling a server that operates the network to distribute the scheduling tasks to the involved clients. In such case, each client is responsible for implementing its own schedule. This offloads the burdensome task of implementing schedules for a large number of clients from the server to a distributed client network.

### BACKGROUND

This invention relates generally to managed networks that include at least one server and a plurality of clients.

End-to-end operations involve interactions between a server and a managed device or client. Generally a server sends a request identifying an operation to a client. The client performs some local operation. The client then sends the results of the local operation back to the server. In many cases, the server must repeat the execution of the end-to-end operation. The time and frequency of the repetition is determined by a schedule associated with the end-to-end operation. In some cases, the schedule is based on a time based criteria. In other cases, other criteria are used for determining the schedule, such as the number of successive connections as one example.

The schedules are conventionally managed by the servers. In order to manage schedules, a server maintains an internal database of schedule objects associated with each end-to-end operation type for each client. On an ongoing basis, the server keeps track of dynamically occurring trigger events. At every trigger event, the server performs database queries and invokes scheduling algorithms to determine whether an end-to-end operation is due on one or more clients.

Since there is one schedule per end-to-end operation type per client, the number of schedules managed by a given server may be relatively large with a large number of clients and/or a large number of operation types. As the number of schedules managed by the server increases sufficiently, a number of problems may arise. The execution of code that responds to trigger events may become time consuming due to the larger number of clients in the network. In order to achieve reasonable performance, server infrastructure needs to be made more powerful. A need for more powerful server infrastructure means that server costs increase due to the need for faster processors, larger memories and larger databases.

In order to achieve higher performance with limited cost increases, complex algorithms may be implemented on the server side. However, this solution leads to longer development cycles and increases the ongoing costs of maintaining complex software. Particularly where the initialization of a server client connection can only be done by the clients, server-based scheduling exerts a huge load on the networking infrastructure at the server side.

Thus, there is a need for techniques to better manage scheduling in networks.

### BRIEF DESCRIPTION OF THE DRAWINGS

FIG. 1 is a schematic depiction of a system in accordance with one embodiment of the present invention;

FIG. 2 is a flow chart for software stored on a storage associated with a server in accordance with one embodiment of the present invention; and

FIG. 3 is a flow chart for software that may be stored on a client in accordance with one embodiment of the present invention.

### DETAILED DESCRIPTION

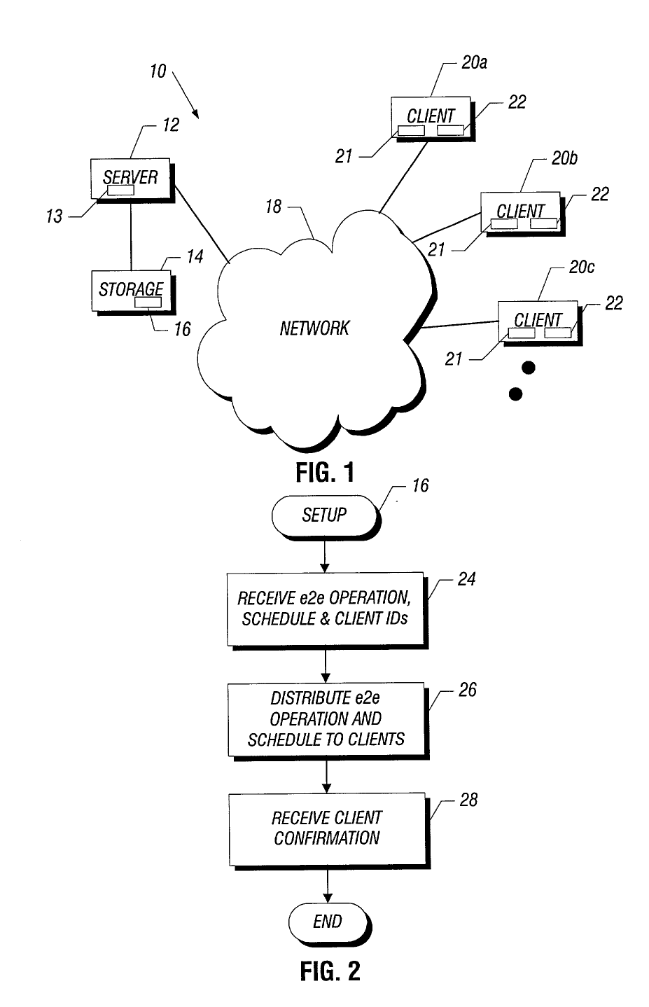

Referring to FIG. 1, a managed network 10 may include a server 12 that serves a plurality of clients 20 over a network 18. The server 12 may include a storage device 14 that stores a software program 16. Clients 20 may likewise include software programs 22 for implementing the managed network 10. The server 12 includes a processor 13 and the clients 20 include processors 21.

Turning next to FIG. 2, the software 16, stored in the storage 14 for enabling the server 12 to set up the network 10, initially receives an end-to-end (e2e)operation, a schedule for the operation and identifiers of the clients involved in the operation in one embodiment. The subject operation, the schedule and the appropriate identifiers may be received as an operator input as indicated in block 24. The server 12 then distributes the end-to-end operation and the schedule to the appropriate clients, as indicated in block 26. Each client remembers its end-to-end operation and associated schedule. When the operation is complete, in some embodiments, the client 20 may provide confirmation back to the server 12 that the schedule has been implemented, as indicated in block 28.

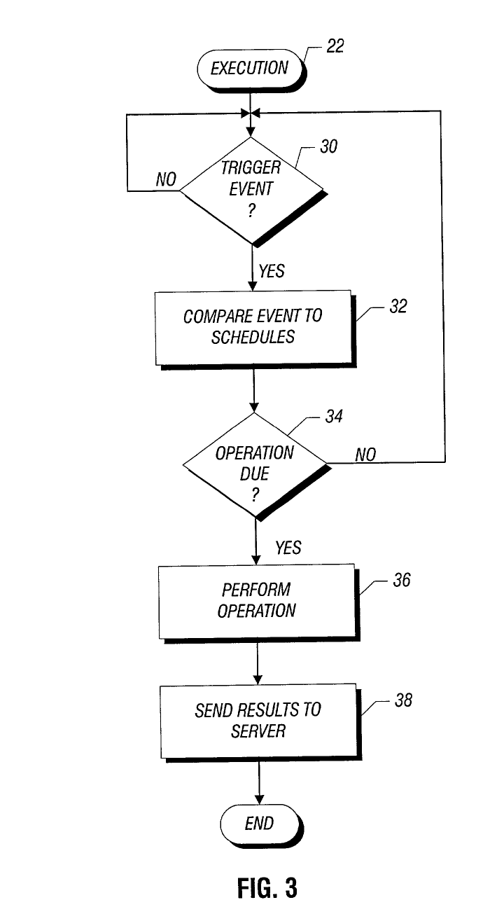

Referring to FIG. 3, the execution software 22, stored on a client 20, may be responsible for executing the client-based schedule. Initially, a trigger event is detected as indicated in diamond 30. When the trigger event is detected, the client 20 compares the trigger event against the schedules received from the server 12 as indicated in block 32. A check at diamond 34 determines whether a given end-to-end operation is now due. If so, the client 20 performs the operation, as indicated in block 36. The results of the operation are then sent to the server 38. The server 12 may store the results in a database associated with the storage 14.

Thus, a client 20 is aware of all scheduled end-to-end operations that relate to that client. Each client 20 tracks the trigger events for itself. The client side software 22 becomes very simple since exactly one client is involved. At appropriate times, the client 20 performs necessary local operations and communicates results to the server 12.

Since the server 12 does not need to track trigger events or execute complex algorithms, a huge computing load is removed from the server 12. In effect, the scheduling load is distributed to the clients 20. This leads to a more scaleable architecture, since adding clients 20 to the network 18 causes a minimal increase in server-side loading.

The network may use a push or a pull communication protocol between the server 12 and the clients 20. For example, the clients 20 may “pull” the schedules from the server 12 or the server 12 may “push” scheduling tasks to the clients 22. In general, communications may be initiated periodically or on an as needed basis by either the server 12 or the clients 22.

Embodiments of the present invention may be utilized in a variety of network managed systems. Included among the potential applications are networks that are wired or wireless, networks that implement television systems such as satellite television systems, systems that involve wireless telephones or personal digital assistants, and any of a variety of other managed network systems.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving a schedule of operations to be performed on a plurality of clients;
distributing the schedule to the clients; and
enabling the clients to implement the schedule.

2. The method of claim 1 including receiving an end-to-end operation, a schedule and the identifiers for involved clients and distributing the schedule to the involved clients using the client identifiers.

3. The method of claim 2 including relying on the clients to implement their own scheduling tasks.

4. The method of claim 1 including requiring clients in a managed network to maintain their own schedules of end-to-end operations.

5. The method of claim 1 including receiving a schedule of end-to-end operations to be performed on a plurality of clients, distributing the schedule for the end-to-end operations to the clients that are responsible for the end-to-end operations and requiring the clients to monitor the schedule to implement the end-to-end operations upon the occurrence of a triggering event.

6. The method of claim 1 including enabling the clients to monitor for a triggering event and in response to the triggering event, implement the scheduled end-to-end operations.

7. An article comprising a medium storing instructions that enable a processor-based system to:
receive a schedule of operations to be performed on a plurality of clients;
distribute the schedule to the clients; and
enable the clients to implement the schedule.

8. The article of claim 7 further storing instructions that enable the processor-based system to receive an end-to-end operation, a schedule and the identifiers for involved clients and distribute the schedule to the involved clients using the client identifiers.

9. The article of claim 8 further storing instructions that enable the processor-based system to rely on the clients to implement their own scheduling tasks.

10. The article of claim 7 further storing instructions that enable the processor-based system to require clients in a managed network to maintain their own schedules of end-to-end operations.

11. The article of claim 7 further storing instructions that enable the processor-based system to receive a schedule of end-to-end operations to be performed on a plurality of clients, distribute the schedule for the end-to-end operations to the clients that are responsible for the end-to-end operations and require the clients to monitor the schedule to implement the end-to-end operations upon the occurrence of a triggering event.

12. The article of claim 7 further storing instructions that enable the processor-based system to enable the clients to monitor for a triggering event and in response to the triggering event, implement the scheduled end-to-end operations.

13. A server comprising:
a processor; and
a storage coupled to said processor storing instructions that enable the processor to:
receive a schedule of operations to be performed on a plurality of clients;
distribute the schedule to the clients; and
enable the clients to implement the schedule.

14. The server of claim 13 wherein said storage stores instructions that enable the processor to receive an end-to-end operation, a schedule and the identifiers for involved clients and distribute the schedule to the involved clients using the client identifiers.

15. The server of claim 14 wherein said storage stores instructions that enable the processor to rely on the clients to implement their own scheduling tasks.

16. The server of claim 13 wherein said storage stores instructions that enable the processor to require clients in a managed network to maintain their own schedules of end-to-end operations.

17. The server of claim 13 wherein said storage stores instructions that enable the processor to receive a schedule of end-to-end operations to be performed on a plurality of clients, distribute the schedule for the end-to-end operations to the clients that are responsible for the end-to-end operations and require the clients to monitor the schedule to implement the end-to-end operations upon the occurrence of a triggering event.

18. The server of claim 13 wherein said storage stores instructions that enable the processor to enable the clients to monitor for a triggering event and in response to the triggering event, implement the scheduled end-to-end operations set forth on said schedule.

19. A method comprising:
receiving from a server a schedule for an end-to-end operation to be performed on a client;
monitoring for a triggering event; and
in response to the detection of the triggering event, initiating the end-to-end operation.

20. The method of claim 19 including sending the results of the operation to the server.

21. The method of claim 19 including comparing an event to a schedule received from the server.

22. An article comprising a medium storing instructions that enable a processor-based system to:
receive from a server a schedule for an end-to-end operation to be performed on a client;
monitor for a triggering event; and
in response to the detection of the triggering event, initiate the end-to-end operation.

23. The article of claim 22 further storing instructions that enable a processor-based system to send the results of the operation to the server.

24. The article of claim 22 further storing instructions that enable a processor-based system to compare an event to a schedule received from the server.

25. A processor-based system comprising:
a processor; and
a storage coupled to said processor storing instructions that enable the processor to:
receive from a server a schedule for an end-to-end operation to be performed on a client;
monitor for a triggering event; and
in response to the detection of the triggering event, initiate the end-to-end operation.

26. The system of claim 25 wherein said storage stores instructions that enable the processor to send the results of the operation to the server.

27. The system of claim 25 wherein said storage stores instructions that enable the processor to compare an event to a schedule received from the server.
